(19) United States
(12) Patent Application Publication
(10) Pub. No.: US 2006/0162667 A1
(43) Pub. Date: Jul. 27, 2006

(54) AQUATIC HABITAT AND ECOLOGICAL TANK

(76) Inventors: Ernest D Papadoyianis, Boca Raton, FL (US); Xavier T. Cherch, Delray Beach, FL (US)

Correspondence Address: MALIN HALEY AND DIMAGGIO, PA, 1936 S ANDREWS AVENUE, FORT LAUDERDALE, FL, 33316, US

(21) Appl. No.: 11/307,013

(22) Filed: Jan. 19, 2006

Related U.S. Application Data
(60) Provisional application No. 60/650,296, filed on Jan. 26, 2005.

(51) Int. Cl. A01K 63/00

(52) U.S. Cl. 119/223

(57) ABSTRACT

A self-contained, floating aquaculture tank for containing fish and other aquatic animal, plant, and algal species. The aquaculture tank includes a series of panels joined together by flexible connecting joints to form a cylinder-shaped tank enclosure with a conical bottom surrounded at or near the open end by a water-resistant and buoyant foam or other material. The tank is placed into a body of water where it floats and maintains the same water temperature as the surrounding body of water. The tank includes a waste cone at the bottom of the tank enclosure to which the lower portion of each panel is attached. The tank may also include devices for harnessing wind or solar energy to power lights, air pumps, and water pumps that may be components of the invention.

### FIELD OF THE INVENTION

The present invention relates generally to fish containment housings, net enclosures or other defined containers, and more particularly to buoyant aquaculture cages, self-contained housings, and submersible habitat structures for rearing fish and the like.

### DESCRIPTION OF THE PRIOR ART

In recent years, the importance of fish in human diets has attained renewed recognition due to dietary research comparing the health benefits as well as negative health impacts of fish and other meats. Consumer demand for fish has increased, and commercial farmers have searched for new techniques for harvesting more fish while lowering costs to maximize profits. Aquaculture, or fish-farming, has gained attention as a viable alternative to commercial harvesting of wild fish populations. Aquaculture is practiced in several different forms, which include pond aquaculture, tank aquaculture, and cage aquaculture.

Cage aquaculture is advantageous because fish, shellfish, and other aquatic species can be harvested more quickly and more efficiently without the use of fishing or trawling vessels and with a lower environmental impact. Moreover, aquaculture tanks can be located offshore or in under-used areas of large lakes, rivers, and estuaries. Aquaculture may also increase the availability of seafood and freshwater fish for public food consumption. Aquaculture also reduces the environmental impact of fishing by eliminating the use of nets for harvesting the farmed species and by reducing the impact of commercial harvesting on wild populations that can produce negative ecological results in a particular marine or freshwater environment.

U.S. Pat. No. 6,539,894, issued to Byrne et al. on Apr. 1, 2003, discloses an aquaculture system particularly designed for the cultivation, containment and growing of various mollusks, and discloses a generally rectangular housing of rigid-molded panels, which include internal openings such that food and mollusks can migrate between chambers. The individual panels constitute interior baffles onto which the mollusks may attach and grow. The '894 patent teaches that the panels are to be constructed of blow-molded plastic, such as polyethylene or similar materials. A foam insert is placed between inner and outer panel sides in a particular embodiment. The closed-cell foam provides the desired buoyancy.

U.S. Pat. No. 5,617,813, issued to Loverich et al. on Apr. 3, 1997, discloses an anchorable and mobile pen system for growing fish, shellfish and the like. The mobile pens are shown in different shapes and utilize a flexible netting form system to enclose the pen between spar buoys. The netting is supported in any desired shape by supporting ring structure.

U.S. Pat. No. 4,351,269, issued to Rines et al. on Sep. 28, 1982, discloses a training device for various fish species, and is designed to control the congregation and feeding habits of the fish. The focus is to cause the fish to congregate in vertical stacks under light-blocking covers contacting the water, however without defined containers which utilize nets, walls or other barriers to the flow of water. The opaque covers are made from fiberglass or similar materials, and can be arranged in any configuration, including square, rectangular, circular or otherwise. Feed is introduced around the perimeter of the device, or alternatively through centralized tubes.

U.S. Pat. No. 5,762,024, issued to Meilahn on Jun. 9, 1998, describes an aquaculture system having a rigid-walled floating tank that is generally cylindrical with a conical bottom. The '024 patent has a disadvantage in that the tank has a rigid wall that does not articulate to absorb the impact of waves and wind. Thus, the '024 invention is more prone to damage by wind and wave action than the articulated tank wall panels of the present invention.

U.S. Pat. No. 4,395,970, issued to Kunkle et al. on Aug. 2, 1983, and U.S. Pat. No. 6,386,146, issued to Knott on May 14, 2002, disclose conventional fish habitats or aquaculture devices utilizing nets, screens, impervious walls and various flotation mechanisms. Many of the references disclose tethering, anchoring and buoyancy systems.

The prior art, however, fails either alone or in combination with other references, to teach or suggest the Applicants' aquaculture tank, nor the design for the generally cylindrical tank enclosure, which is multi-sectional with special connecting gaskets, allowing for articulation for solid panel-type sections. The prior art does not disclose or illustrate many of the components of the instant aquatic ecological containment vessel, including the generally cylindrical tank enclosure with the conical-shaped bottom, which also incorporates articulating panels, or the hybrid functionality.

### SUMMARY OF THE INVENTION

Applicants' system comprises an innovative, floating, semi-rigid containment system for intensive aquaculture production that can be used in a variety of deepwater and shallow-water applications including lakes, ponds, rivers, estuaries, preformed impoundments (PFI) such as quarries, and other near-shore and offshore marine environments. The generally cylindrical tank enclosure is multi-sectional with specialized connecting gaskets (such as neoprene) allowing articulation between solid joining panel sections, and a conical-shaped bottom for optimal waste collection.

The self-contained aquaculture tank constitutes a floating containment system that is placed within a larger body of water. In this regard, the aquaculture tank functions with the solid waste management characteristics of a recirculation system. To achieve this “hybrid functionality,” the prototype aquaculture tank is designed as a semi-rigid, floating structure, constructed of several articulating plastic (likely fiberglass or polypropylene) panels. While the lightweight plastic panels allow optimum shape and rigidity, the articulating gaskets/joints provide both directional and torque flexibility to ensure an acceptable commercial life.

The physical properties of the tank includes a cylindrical shape “with a cone-shaped bottom” and a Cornell-style Dual-drain. The aquaculture tank is designed with a floating collar similar to existing net pens to rest on the water's surface with the tank itself submerged. Due to its floating design, the conical bottom could have a greater degree of pitch than most land-based units, thereby permitting the tank to be built deeper.

The unit may include solar energy panels or another power source to power an electric regenerative air blower for pumping water from the exterior environment into the tank to provide an oxygenated water source for said aquaculture tank.

An object of the invention is to provide a self-contained aquaculture tank habitat for farm-raising aquatic animal, plant, and algal species, including, but not limited to, finfish, crustaceans, and seaweed or kelp, that is economically and environmentally superior to current conventional cages and net pens available on the market.

Another object of this invention is to afford protection from predators to the fish or other aquatic species contained within the aquaculture tank.

Still another object of this invention is to reduce the energy consumption typical for commercial aquaculture by using alternative sources of energy, such as solar, wave, and wind power.

Yet another object of the invention is to provide an aquaculture tank that includes a solid waste recovery and disposal system to reduce negative environmental impact on the body of water in which the invention is located.

A further object of the invention is to provide an aquaculture tank that will isolate the fish or species contained therein from the external environment to limit or eliminate the effects of adverse aquatic conditions, such as thermal lake inversion or for disease treatment.

Still a further object of this invention is to provide an aquaculture tank that is cost-efficient, easily transported, and easily set up for use in remote locations.

In accordance with these and other objects which will become apparent hereinafter, the instant invention will now be described with particular reference to the accompanying drawings.

### BRIEF DESCRIPTION OF THE DRAWINGS

FIG. 1 illustrates a perspective view of the invention.

FIG. 2 illustrates a cross-sectional, elevational side view of the invention.

FIG. 3A illustrates a unitary, cylindrical embodiment of a flotation device connected to a tank enclosure panel.

FIG. 3B illustrates an alternate embodiment of the flotation device wherein said flotation device comprises more than one piece of parallelepiped-shaped buoyant material.

FIG. 4A shows a top perspective view of a tank enclosure.

FIG. 4B shows a bottom perspective view of the tank enclosure.

FIG. 5A shows a top perspective view of a waste cone engaged with four tank enclosure panels attached by connecting joints.

FIG. 5B shows a bottom perspective view of the waste cone engaged with four tank enclosure panels attached by connecting joints.

FIG. 5C shows a perspective side view of the waste cone engaged with three tank enclosure panels with a fourth tank enclosure panel having been removed.

FIG. 5D shows an exploded perspective view of the waste cone, connecting gaskets, and three tank enclosure panels.

FIG. 6 shows an exploded perspective view of the tank enclosure including panels, connecting gaskets, and waste cone.

FIG. 7 shows a schematic diagram of the invention.

FIG. 8A illustrates an arrangement of three aquaculture tanks connected together by elevated or floating docks or catwalks.

FIG. 8B illustrates another arrangement of four aquaculture tanks connected together by elevated or floating docks or catwalks.

FIG. 8C illustrates still another arrangement of seven aquaculture tanks connected together by elevated or floating docks or catwalks.

FIG. 9 illustrates an apparatus typically used in the prior art to contain fish and other aquatic species for aquaculture purposes.

FIG. 10 illustrates a view of a means for attaching the connecting gasket to a panel of the tank enclosure.

The instant description and drawings illustrate to one of ordinary skill in the art, how to manufacture, assemble and utilize the instant ecological aquaculture habitat and containment vessel, and fishery system.

### DETAILED DESCRIPTION

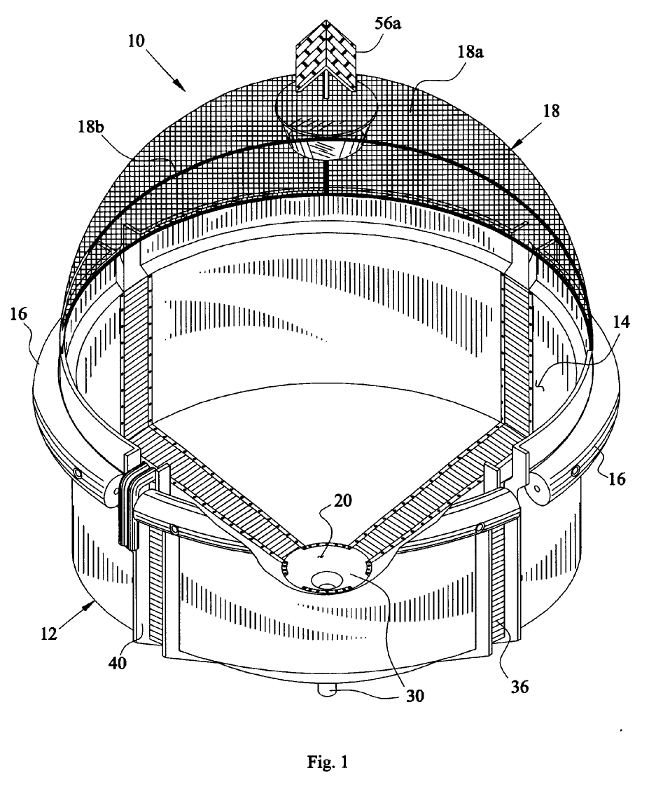

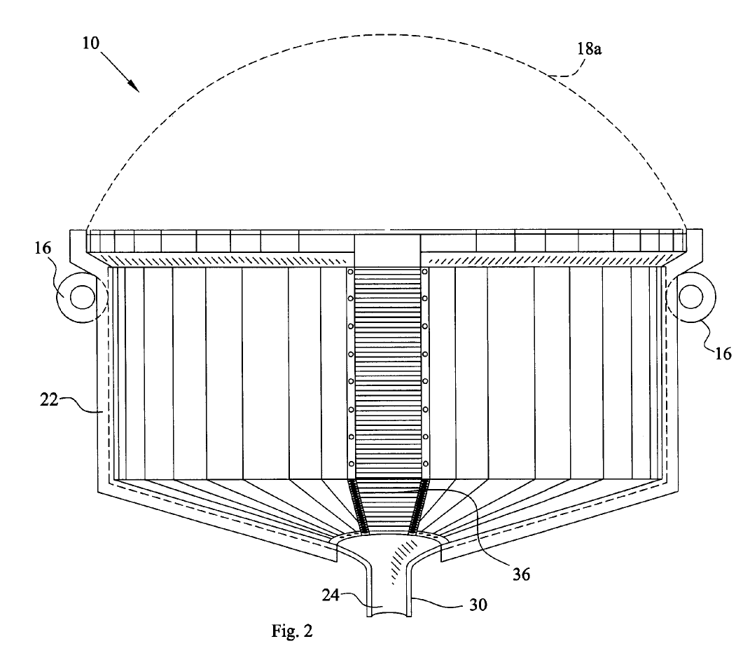

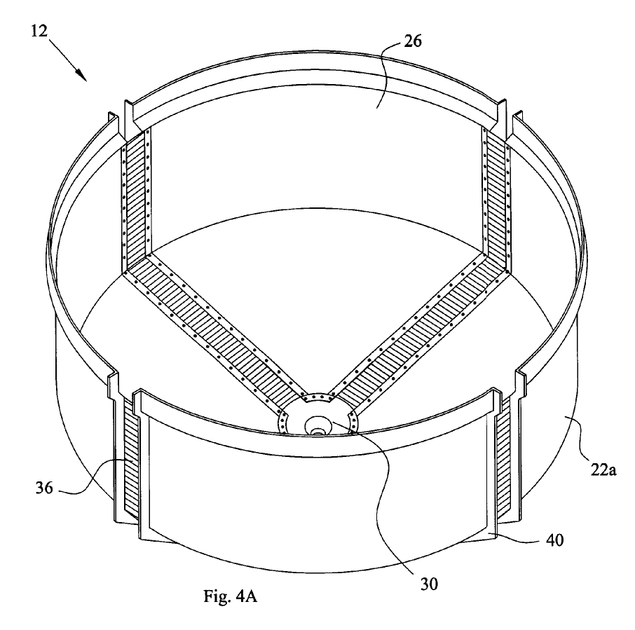

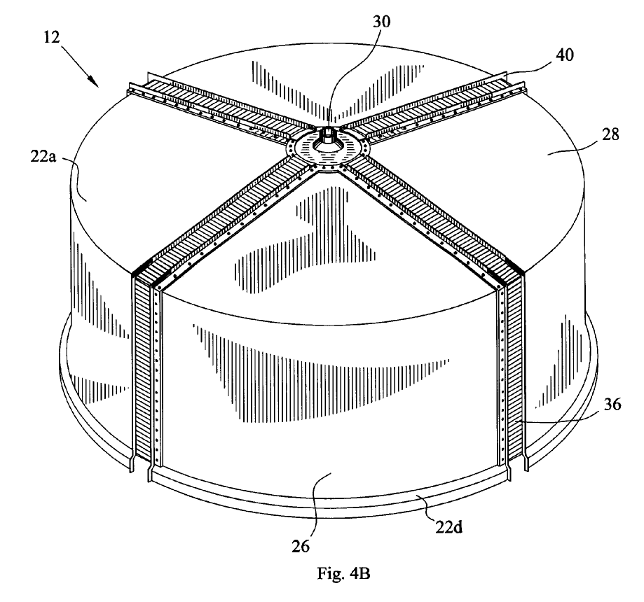

FIG. 1 illustrates a self-contained, submersible aquaculture tank 10 for containing fish, shellfish, and other aquatic food and ornamental species. The aquaculture tank 10 comprises a cylindrical tank enclosure 12 with a circular open end 14, a flotation device 16 connected to said tank enclosure 12, and a tank cover 18 engaged with said tank enclosure 12. The aquaculture tank may also include an anchoring system (not shown in the drawings) for securing said aquaculture tank 10 in a stationary position within a body of water. As shown in FIGS. 4A and 4B, the tank enclosure 12 is comprised of two or more, but preferably with four to eight, curved panels 22. Each panel 22 includes a convex outer surface 22a, a concave inner surface 22b, a bottom end 22c, and an upper lip 22d to which said flotation device 16 and the tank cover 18 are attached. FIG. 2 shows a cross-sectional view of the aquaculture tank 10 with the flotation device 16 and the tank cover 18 connected to the upper lip 22d of said panels 22. When joined together, said panels 22 form the tank enclosure 12, which has the large circular open end 14 at the top and a smaller aperture 20 at the bottom of said tank enclosure 12. Moreover, each panel 22 of said tank enclosure 12 is also a single unit in which the concave inner surface 22b includes a vertical interior wall 26 that adjoins a lower sloping portion 28 of said panel 22. The panels 22 provide the tank enclosure 12 with an interior shape that conducts waste produced by the fish or other species toward a waste cone 30 installed at the bottom of said tank enclosure 12 at a point where the bottom ends 22c of the panels 22 connect to form aperture 20. Said tank enclosure panels 22 are constructed from a molded synthetic material, such as polypropylene, polyethylene, or laminated fiberglass and resin.

The aquaculture tank enclosure 12 is mostly cylindrical in shape, and preferably, has a conical-shaped bottom that is contiguous with the cylindrical portion of the tank enclosure 12. The conical shape of the bottom of the tank enclosure 12 may be sloped at an angle between 0 and 180 degrees. Alternatively, the bottom the tank enclosure 12 may be flat with no slope rather than conical in shape. The greater is the angle of the slope of the conical bottom of said tank enclosure 12, the greater is the depth and volume of water said tank enclosure can accommodate.

The tank cover 18 of the aquaculture tank 10 comprises a screen or mesh material 18a disposed over a lightweight frame 18b that is constructed from plastic, aluminum, or any other suitable lightweight, rigid material. The tank cover 18 may be disposed either entirely or partially over the open end 14 of the tank enclosure 12 to which said tank cover 18 also attaches. The tank cover 18 serves to protect the farmed species from predators, and particularly from birds, such as gulls, pelicans, eagles, and ospreys. The tank cover 18 may also aid in containing the fish to prevent them from jumping out of the tank enclosure 12 and escaping into the surrounding body of water.

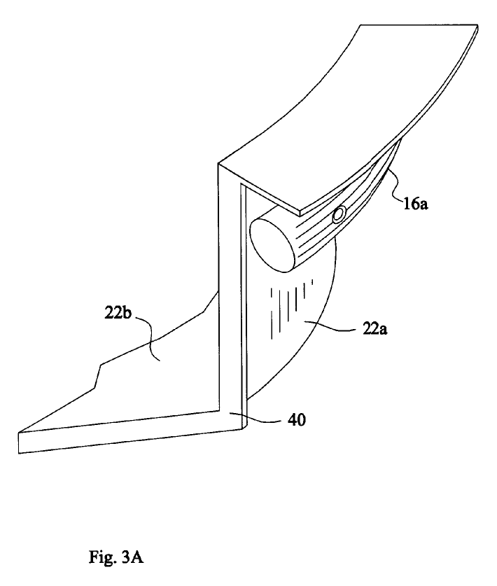

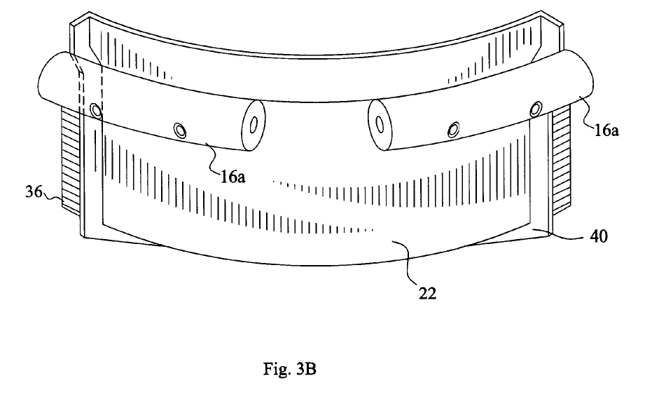

The flotation device 16 of the aquaculture tank 10 comprises a floating collar 16 that surrounds the tank enclosure 12 and includes one or more pieces of a buoyant material, such as an elastomer material or extruded polystyrene. Said flotation device 16 is attached to the outer surface 22a of the panels 22 of said tank enclosure 12 at a point below the lip 22d of the tank enclosure 12 so as to allow portions of the tank enclosure panels 22 to rise above the water level to prevent fish or other aquaculture species from escaping by jumping over the lip 22d of said tank enclosure 12. In this manner, an area of freeboard is provided between the water line and the lip 22d of the tank enclosure 12. Generally, the flotation device 16 will comprise one or more cylindrical sections 16a of the buoyant material attached around the perimeter below the lip 22d of said tank enclosure 12. However, the section or sections 16a of buoyant material may also be shaped as a triangular prism, parallelepipeds, or any other suitable shape. The flotation device 16 is illustrated in FIGS. 3A and 3B.

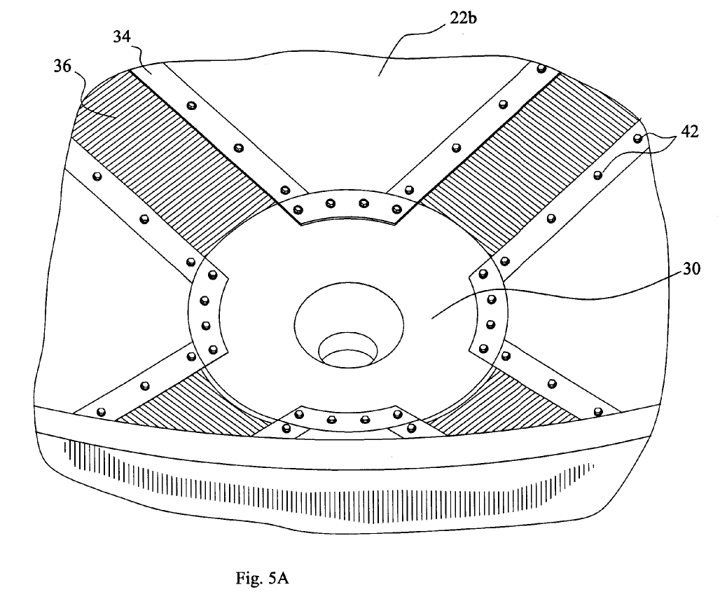

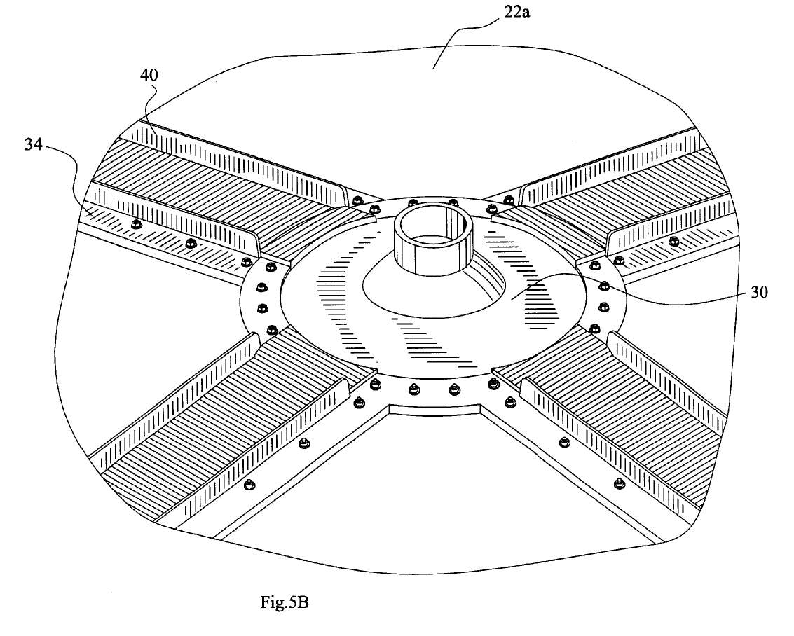

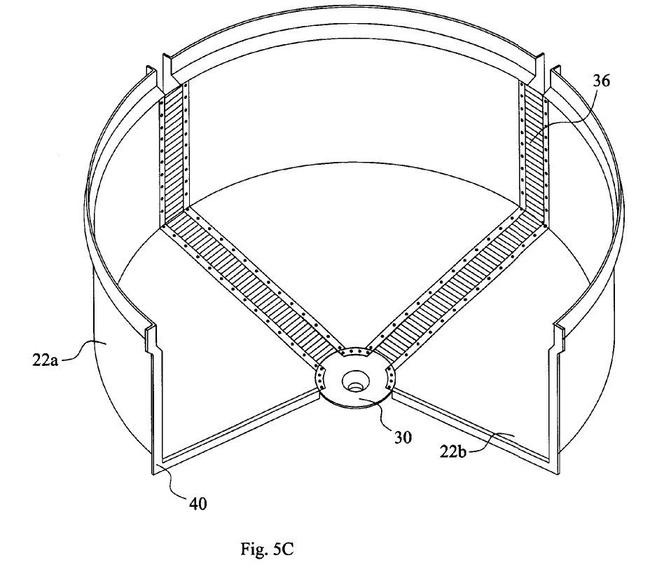

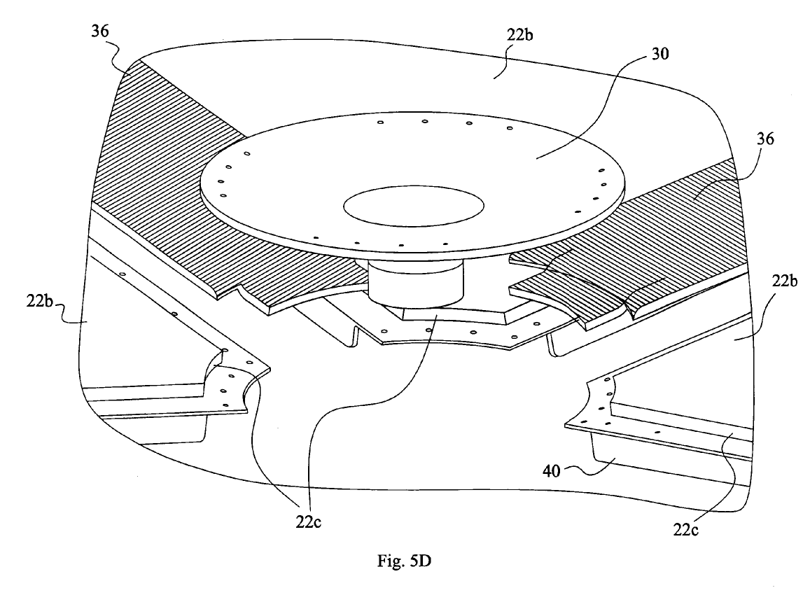

The bottom end 22c of the panels 22 of said tank enclosure 12 are attached to the waste cone 30 into which wastes produced by the fish or other aquaculture species are collected and disposed of through a drain aperture 24 passing through said waste cone 30. FIGS. 5A through 5D illustrate the waste cone 30 situated within aperture 20 and attached to panels 22. Thus, the waste cone 30 serves to both collect and dispose of waste produced by the fish or other species contained within the aquaculture tank 10, but also to join all of the panels 22 at the bottom center of the tank enclosure 12. Said waste cone 30 may be positioned either inside or outside of the tank enclosure 12. The waste cone 30 can be connected to the adjoining panels 22 via a recessed flange 32, or said waste cone 30 may be bolted in an overlapping configuration with the adjoining panels 22 on the inner surface 22b of the tank enclosure 12 or bolted to the outer surface 22a of the tank enclosure panels 22 at the bottom center of the tank enclosure 12. The waste cone 30 is funnel-shaped and may be constructed from a metal, polymer, plastic, or any other suitable material.

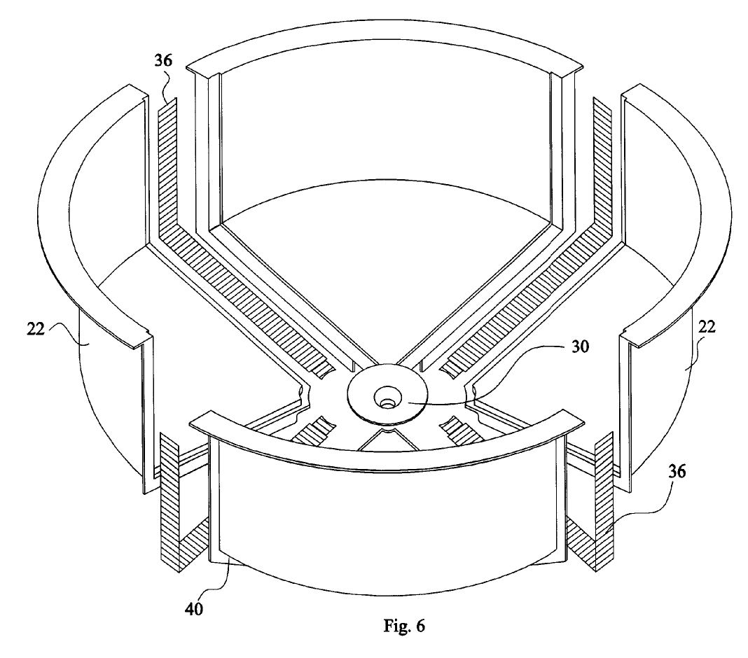

Each panel 22 of said tank enclosure 12 is connected to the adjoining panel 22 by a connecting joint 34. The connecting joint 34 is formed between side ends 22e of adjoining panels 22 to allow articulation that will eliminate the danger of cracking of the tank enclosure 12 during impact from physical stress, such as wind and wave action. The connecting joints 34 allow the panels 22 of the tank enclosure 12 to articulate and move within a horizontal plane during impact from these or other physical stressors on said aquaculture tank 10. The connecting joint 34 between adjoining panels 22 is held together by a connecting gasket 36. Said connecting gasket 36 is constructed from a durable, flexible, water-resistant elastomer or plastic material, such as polyurethane or polypropylene, but preferably from neoprene. In the most preferred embodiment of the invention, the connecting gasket 36 is manufactured from EPDM, a type of neoprene. The connecting gaskets 36 are illustrated in FIG. 6 in an exploded view with panels 22 and waste cone 30. The flexible material forming the connecting gaskets 36 further includes a rigid, yet flexible, inner mesh (not illustrated in the drawings) comprised of fiberglass, steel, titanium, or another suitable metal or other material.

Additionally, the connecting gasket 36 may include a rod (not shown in the drawings) oriented vertically along the connecting joint 36 for maintaining the shape and rigidity of the aquaculture tank 10 as well as for allowing the connecting gasket 36 and adjoined panels 22 to return to the original cast or shape following an articulation event. This rod may be constructed from plastic, fiberglass, steel, titanium, or any other suitable metal or material having shape memory as a property. In another embodiment of the invention, the connecting gaskets 36 may include a plurality of bands or strips of titanium or another shape memory metal or material (not shown in the drawings) attached across each of said joints and secured to the panels 22 on either side of a particular connecting joint 34. The shape memory property of the metal not only returns the gasket 36 to the original shape and configuration, but also serves to further secure the attachment of adjoining articulating panels 22 at each connecting joint 34.

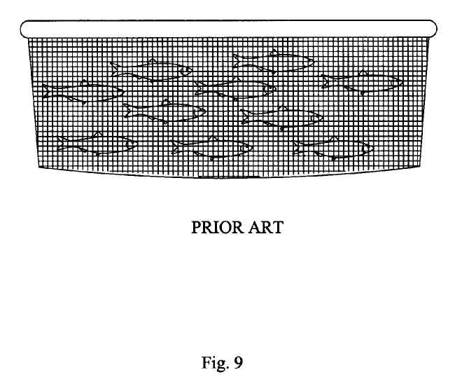

As shown in FIG. 9, prior art inventions have used simple floating baskets or cages for containing farmed fish species and have not included features designed to reduce the impact caused by physical environmental stressors or design features that ensure the adequate removal of waste from the system. Both the cylindrical shape and the functional components, such as the connecting joints 34 and connecting gaskets 36, of the applicants' invention provide efficient means for withstanding wind and wave action impacting the aquaculture tank 10 as well as for collecting and disposing of waste produced by the farm-raised fish or other species.

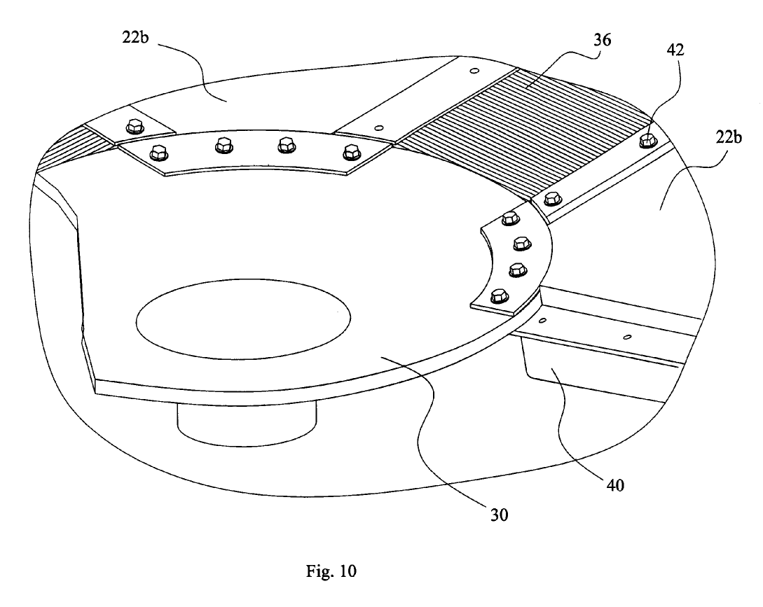

Each tank panel 22 and the adjoining connecting gasket 36 engage via a flanged edge 40 that may be oriented at a 90-degree angle to the outer surface 22a of the tank panel 22. The flanged edge 40 may be recessed in relation to the outer surface 22a of the tank panel 22 and an outer surface 36a of the connecting gasket 36, thereby creating a smooth exterior surface on the tank enclosure 12. The connecting gaskets 36 can be attached to their respective tank enclosure panels 22 using rivets, ultrasonic welding, but preferably, using a series of spaced bolts, washers, and lock washers 42 on both opposing sides of the connecting joint 34. The spaced bolts 42 are illustrated in FIG. 10. The connection of the panels 22 and connecting gaskets 36 does not render the aquaculture tank 10 impermeable to water, and some water seepage into the tank 10 from the surrounding body of water is to be expected. Water seepage into and out of the aquaculture tank 10 does not affect the performance of said aquaculture tank 10.

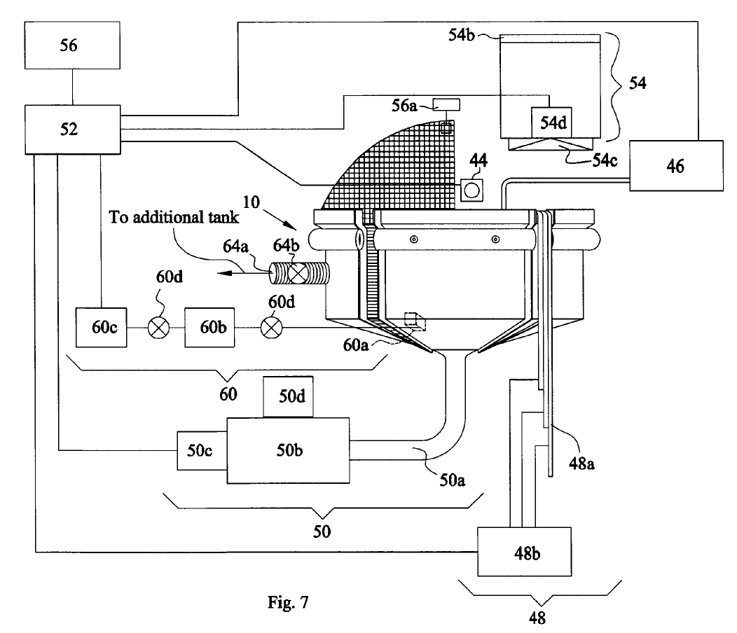

As illustrated in FIG. 7, lights 44 can be installed as a part of this invention to allow monitoring of the fish or other species contained within said aquaculture tank 10. The aquaculture tank 10 may also include an air pump 46 or an air blower 48b of a water-pumping apparatus 48 for pumping clean oxygenated water from a source of water, preferably from the surrounding body of water, into the tank enclosure 12 to oxygenate the water inside the tank enclosure 12.

The water-pumping apparatus 48, shown in FIG. 7, preferably comprises an organ pipe air-lift system 48a and the regenerative blower 48b. The regenerative blower 48b forces air into submersed pipes 48a, which lifts water into the aquaculture tank 10. The design of the organ pipe air-lift system 48a resembles the staggered, varied lengths of pipes found on a pipe organ. The different pipe lengths allow the system 48a to draw water from different depths of the body of water as required by the user. The ability to draw water from various depths of the body of water permits year-round temperature regulation of the aquaculture tanks 10. Said pipes 48a may be constructed from polyvinyl chloride (PVC) or any other suitable material. The pipes of the organ pipe air-lift system 48a are positioned vertically within the water and against the side of the aquaculture tank 10. The tops of said pipes 48a extend above the lip 22d of the tank enclosure 12 and include a pipe fitting angled within a range of 45 to 90 degrees to direct water flow from said pipes 48a around the perimeter of said aquaculture tank 10. For increased efficiency, the tops of the pipes 48a may also be fitted through apertures of a slightly larger diameter that may be cut through the panel or panels 22 of the tank enclosure 12.

Preferably, the aquaculture tank 10 includes a solid waste recovery system 50 for removing waste collected inside the waste cone 30 at the bottom of the tank enclosure 12. Said solid waste recovery system 50, shown in FIG. 7, comprises a flexible tube 50a connected to the drain aperture 24 of the waste cone 30, a storage container 50b, a separator (not shown in the drawings) disposed inside of the storage container 50b, a filter screen (also not shown in the drawings), a low-voltage piston-driven actuator 50c for driving the filter screen, a pump 50d, and a programmable timing circuit 52. In the preferred embodiment of the solid waste recovery system 50, the storage container 50b includes two compartments, however, two separate storage tanks could also be used in place of the container with multiple compartments. At predetermined intervals of time, the programmable timing circuit 52 activates the pump 50d causing said pump to suction both water and waste from the waste cone 30 to the first compartment of the storage container. The piston-driven actuator 50c then compresses the waste inside of said first compartment causing the liquid and solid wastes to be separated. Liquid wastes flows into the second compartment of the storage container 50b from which said liquid waste is released back into the surrounding body of water. The remaining solid waste is removed from the first compartment of the storage container 50b using a pump located on a service barge (not shown in the drawings). Removal of the waste from the tank enclosure 12 reduces the negative environmental impact such waste could have on the ecological health of the surrounding body of water and also maintains a clean and healthy environment for the fish or other species inside the tank enclosure 12.

Preferably, the aquaculture tank 10 also includes an automated feeding system 54 to provide food to the fish or other aquatic species contained therein. The feeding system, illustrated in FIG. 7, comprises a preformed, weather-resistant, synthetic hopper 54a having a holding capacity preferably within a range of 100 to 1,000 pounds, although larger or smaller capacity hoppers may also be used. The feeding system 54 further comprises a hinged, weather-sealed feed loading door 54b located at the top of the hopper 54a, a propeller 54c for dispensing food from the hopper 54a, a low-voltage motor 54d for rotating the propeller 54c, a battery bank and source of power 56 to drive the motor 54d, and a programmable timing circuit 52 to ensure that food is released into the tank 10 at predetermined intervals of time. The feeding system 54 can release predetermined amounts of food preferably twenty times per day. A solar panel 56a provides the preferred source of energy for the feeding system 54. Feed may be loaded into the hopper 54a of the feeding system 54 either manually or by a mechanical system. The timing circuit 52 is programmed to activate the motor 54d a predetermined number of times each day for a specific period of time during each activation. When the motor 54d is activated, the feed drops through an aperture in the bottom of the hopper 54a and is spread over a predetermined area within the tank enclosure 12 by the spinning of the propeller 54c. The size of the feeding area over which feed is spread by the propeller 54c can be modified by adjusting the speed at which said propeller spins.

In addition to the air blower 46 or pump, the aquaculture tank 10 includes an oxygen injection back-up system 60, which is designed to operate independently from said air pumps 46. The oxygen injection back-up system 60 is illustrated in FIG. 7. Moreover, the oxygen injection backup system 60 may be used to isolate the aquaculture tank 10 from the external environment of the surrounding body of water by providing an internal source of oxygen, thereby eliminating the reliance on the surrounding body of water as a source of oxygen for said tank 10. Said oxygen injection back-up system 60 comprises a passive oxygen diffusion system 60a placed at the bottom of the tank enclosure 12. The passive oxygen diffusion system 60a may be comprised of diffuser hoses, micro-pore air stones, or any other similar aeration device that can be used to distribute oxygen or air through a body of water. An oxygen tank 60b, an oxygen generator 60c, an oxygen compressor (not shown in the drawings), or all three of these components may be located near the aquaculture tank 10 to supply or produce a source of oxygen to the oxygen injection back-up system 60. Oxygen supply distribution may be controlled automatically or manually through a series of valves, solenoid valves, or any other suitable means 60d for controlling oxygen supply flow. The valves 60d are also used to distribute oxygen from the oxygen generator 60c to the oxygen tank 60b. Depending upon the needs of the user, one or more oxygen tanks 60b may be maintained adjacent to the aquaculture tanks 10 to store oxygen produced by the oxygen generator 60c and to supply oxygen to the aquaculture tanks 10 through the oxygen injection back-up system 60.

The aquaculture tank 10 includes a power source 56 that is preferably harnessed from an alternative energy source, such as solar, wave, or wind energy, to power lights, water or air pumps, and any other electrical or mechanical components incorporated as part of said aquaculture tank 10. However, any suitable power source 56 may be utilized, including electrical connections or fuel-supplied generators. When a solar panel 56a or wind turbine is used as the power source 56, said solar panel 56a or wind turbine may be connected to the apex of the frame 18b of the tank cover 18 for maximum exposure to sunlight or wind. Location on the apex of the tank cover frame 18b also prevents the aquaculture tank 10 from creating shadows or obstructions that can block solar or wind energy from reaching the solar panels 56a or wind turbines installed on the aquaculture tank 10. The power source 56 may also be located on the floating docks 62 that connect multiple aquaculture tanks, or the power source may be located on land and connected by wires or other appropriate means to the electrical and mechanical components of the aquaculture tank. The same power source 56 or multiple power sources may be used to power any or all of the electrical and mechanical components of the invention.

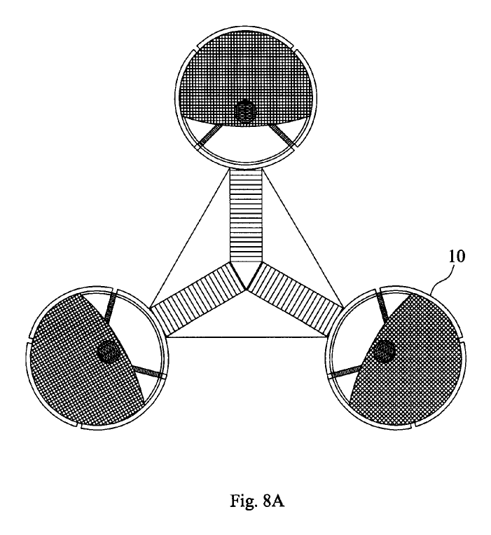

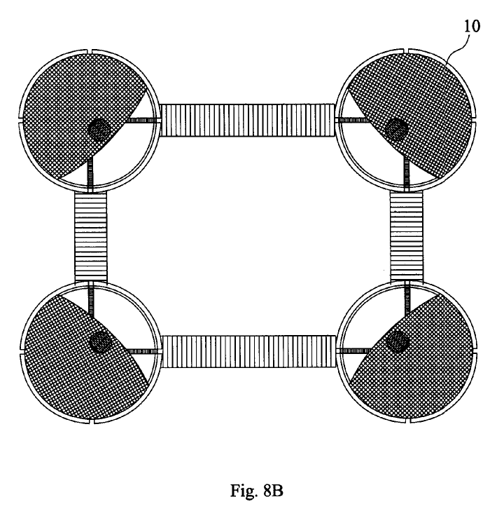

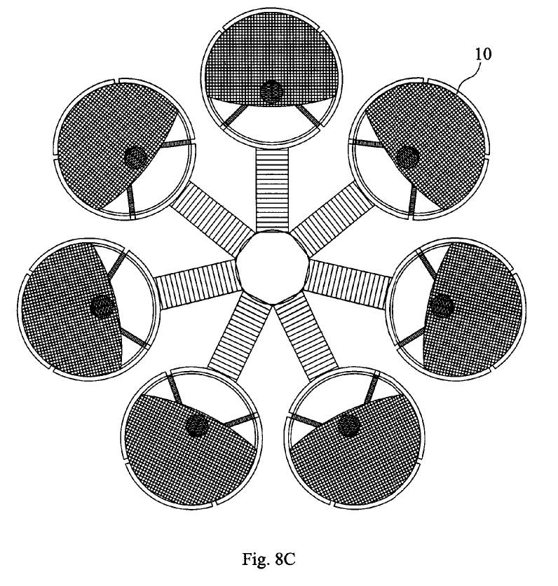

In the preferred embodiment of the invention, several aquaculture tanks 10 are interconnected by docks, catwalks, or gangways 62 either elevated above or floating on the surface of the body of water in which said aquaculture tanks 10 are located. The arrangement of two or more aquaculture tanks 10 within the body of water in certain predetermined configurations allows for maximum use of the available surface area in the body of water. As shown in FIGS. 8A through 8C, the aquaculture tanks are shown arranged and interconnected in groups of three, four, and seven, respectively, however, any number of said tanks may be arranged in any geometric configuration and be interconnected by floating docks and tubes or pipes for moving fish from one tank to another. Said aquaculture tanks 10 may be serviced from a land-connected floating dock with additional floating docks 62 positioned around the perimeter of the aquaculture tanks 10 for improved access. Access to each aquaculture tank 10 is necessary for maintenance, supplying food, and for observation of the fish or other species. An aquaculture tank 10 or groups of aquaculture tanks may also be anchored in bays or offshore areas of a body of water. When anchored offshore, a centralized platform 62a, shown in FIG. 8A, may provide access to the group of interconnected tanks 10. A service barge may be used to supply and provide access to aquaculture tanks anchored in offshore areas not connected to land by a floating dock. When floating docks 62 are used to provide access to the tanks 10, said floating docks 62 may be connected to the aquaculture tanks 10 by flexible connecting means, such as hinges, bungee cords, nylon ropes, or any other suitably strong and flexible material. The connecting means chosen must allow both the tank 10 and the floating dock 62 to rise and fall with changes in water level produced by tides and wave action.

The grouped aquaculture tanks 10 each include a porthole gate valve interface 64 for moving and transporting fish between tanks 10. As illustrated in FIG. 7, the porthole gate valve interface 64 comprises a flexible pipe 64a having a valve 64b connected to and passing through an aperture through panel 22 on each of two adjacent aquaculture tanks 10. Said porthole gate valves 64b may be opened or closed as desired by the user to allow movement and transport of fish or other aquatic species from one aquaculture tank 10 to another aquaculture tank 10.

A software program and timing circuit 52 (shown in FIG. 7) or sensors can be used to automatically control the operation of any electrical or mechanical components, such as air pumps, water pumps, feeding system, oxygen injection back-up system, solid waste recovery system, or lights, included as a part of the invention.

The instant invention has been shown and described herein in what is considered to be the most practical and preferred embodiment. The applicants recognize, however, that departures may be made therefrom within the scope of the invention and that obvious modifications will occur to a person skilled in the art.

What is claimed is:

1. A self-contained, submersible aquaculture tank, comprising:
a primary semi-rigid enclosure, said enclosure including a plurality of articulating panels; and
a plurality of flexible joints;
said plurality of articulating panels securely attached and connected to said plurality of flexible joints, one of said flexible joints being interposed between two adjacent articulating panels;
wherein said primary semi-rigid enclosure provides for movement of said panels.

2. The aquaculture tank of claim 1, wherein a flotation device is connected to said tank enclosure;
wherein said flotation device preferably comprises a floating collar surrounding said tank enclosure that includes one or more pieces of a buoyant material, such as an elastomer material or extruded polystyrene.

3. The aquaculture tank of claim 1, wherein said enclosure of articulating panels forms a tank that has a cylindrical upper portion and a flat or cone-shaped bottom portion that is contiguous with the upper cylindrical portion of said tank.

4. The aquaculture tank of claim 1, wherein said tank enclosure is comprised of two or more, but preferably between four and eight, curved panels, each panel having a convex outer surface, a concave inner surface, a bottom end, and an upper lip to which said floating collar and tank cover are attached.

5. The aquaculture tank of claim 3, wherein said panels are constructed from a molded synthetic material, such as polypropylene, polyethylene, or laminated fiberglass and resin.

6. The aquaculture tank of claim 1, wherein each panel of said tank enclosure is a single unit in which the concave inner surface includes a vertical interior wall that adjoins a lower sloping portion of said panel.

7. The aquaculture tank of claim 1, wherein said tank enclosure is engaged by a tank cover comprising a screen or mesh material disposed over a lightweight frame that is constructed from plastic, aluminum, or any other suitable lightweight, rigid material.

8. The aquaculture tank of claim 7, wherein said flotation device is attached to the outer surface of the panels of said tank enclosure at a point below the lip of the tank enclosure so as to allow portions of the tank enclosure panels to rise above the water level to prevent fish or other aquaculture species from escaping by jumping over the lip of said tank enclosure.

9. The aquaculture tank of claim 7, wherein the bottom end of the panels of said tank enclosure are attached to a waste cone into which wastes produced by the fish or other aquatic species are collected and disposed of through a drain aperture passing through the bottom of said waste cone.

10. The aquaculture tank of claim 3, wherein each panel of said tank enclosure is connected to the adjoining panel by a connecting joint, said connecting joint being formed between side ends of adjoining panels, to allow articulation that will eliminate the danger of cracking of the tank enclosure during impact from physical stress, such as wind and wave action.

11. The aquaculture tank of claim 10, wherein each connecting joint between adjoining panels is held together by a connecting gasket, said connecting gasket being constructed from a durable, flexible, water-resistant elastomer or plastic material, such as polyurethane or polypropylene, but preferably from neoprene.

12. The aquaculture tank of claim 11, wherein the flexible material forming the connecting gaskets includes a rigid, yet flexible, inner mesh comprised of fiberglass, steel, titanium, or another suitable metal or other material.

13. The aquaculture tank of claim 10, wherein the connecting joint may include a rod oriented vertically along the joint for maintaining the shape and rigidity of the aquaculture tank as well as for allowing the connecting joint and adjoined panels to return to the original cast or shape following an articulation event, said rod being constructed from plastic, fiberglass, steel, titanium, or any other suitable metal or material having shape memory as a property.

14. The aquaculture tank of claim 10, wherein said connecting joints allow the panels of the tank enclosure to articulate and move within a horizontal plane during impact or other physical stress on said aquaculture tank, such as movement of the tank by waves in the body of water in which said tank is located.

15. The aquaculture tank of claim 10, wherein each tank panel and the adjoining connecting gasket engage via a flanged edge that may be oriented at a 90-degree angle to the outer surface of the tank panel.

16. The aquaculture tank of claim 15, wherein the flanged edge may be recessed in relation to the outer surface of the tank panel and an outer surface of the connecting gasket, thereby creating a smooth exterior surface on the tank enclosure.

17. The aquaculture tank of claim 11, wherein the connecting gaskets may be attached to the respective tank enclosure panels using rivets, ultrasonic welding, but preferably, using a series of spaced bolts, washers, and lock washers installed on both opposing sides of the connecting joint.

18. The aquaculture tank of claim 9, wherein said aquaculture tank includes a solid waste recovery system for removing waste collected inside the waste cone at the bottom of the tank enclosure.

19. The aquaculture tank of claim 18, wherein said solid waste recovery system comprises:
a flexible tube connected to the drain aperture of the waste cone;
one or more storage containers, wherein each storage container has once or more, but preferably two, compartments for holding waste;
a separator disposed inside of the storage container;
a filter screen;
a low-voltage piston-driven actuator for driving the filter screen;
a pump; and
a programmable timing circuit.

20. The aquaculture tank of claim 1, wherein said aquaculture tank includes an air blower or air pump for pumping oxygenated water from the external environment into the tank enclosure.

21. The aquaculture tank of claim 1, wherein said aquaculture tank includes a pumping apparatus for pumping clean water from a source of water, preferably the surrounding body of water, into the tank enclosure;
wherein said pumping apparatus preferably comprises an organ pipe air-lift system and a regenerative blower.

22. The aquaculture tank of claim 1, wherein said aquaculture tank includes a power source that is preferably harnessed from an alternative energy source, such as solar, wind, or wave energy, to power lights, water or air pumps, and any other electrical or mechanical components incorporated as part of said aquaculture tank.

23. The aquaculture tank of claim 1, wherein said aquaculture tank may include an automated feeding system to provide food to the fish or other aquatic species contained therein.

24. The aquaculture tank of claim 1, wherein said aquaculture tank may include a software program and timing circuit or sensors to automatically control the operation of any electrical or mechanical components, such as air pumps and blowers, water pumps, feeding system, or lights, included as a part of the invention.

25. The aquaculture tank of claim 1, wherein said aquaculture tank includes an oxygen injection back-up system that comprises a passive oxygen diffusion system connected or placed at the bottom of the tank enclosure to supply oxygen to the aquaculture tank.

26. The aquaculture tank of claim 1, wherein said aquaculture tanks are arranged in groups of two or more interconnected by floating docks or by elevated catwalks or gangways to provide access to each tank for maintenance, supplying food, and for observation.

27. The aquaculture tank of claim 26, wherein said aquaculture tanks include a porthole gate valve interface for moving and transporting fish between tanks, said porthole gate valves comprising a flexible pipe connected to and passing through a panel on each of two adjacent aquaculture tanks; and
wherein said porthole gate valves may be opened or closed as desired by the user to allow movement and transport of fish or other aquatic species from one aquaculture tank to another aquaculture tank.

28. A self-contained, submersible aquaculture tank for containing fish and other aquatic animal, plant, and algal species, comprising:
means for containing said fish or other species, said means for containing being semi-rigid; and
means for articulating said means for containing
wherein said means for containing are securely attached and connected to said means for articulating to provide movement of said means for containing.

29. The aquaculture tank of claim 28, wherein the invention also includes means for floating that is attached to the outer surface of the panels of said means for containing at a point below a lip of the panels of the means for containing so as to allow portions of the panels to rise above the water level to prevent fish or other aquatic species from escaping by jumping over the lip of said tank enclosure as well as to prevent fish and other species from the surrounding body of water from infiltrating the aquaculture tank by jumping into the means for containing.

30. The aquaculture tank of claim 28, wherein said means for containing comprises two or more, but preferably between four and eight, curved panels, each panel having a convex outer surface, a concave inner surface, a bottom end, and an upper lip to which said means for floating and said means for covering are attached.

31. The aquaculture tank of claim 28, wherein the invention further includes:
means for connecting adjoining panels while permitting articulation that will eliminate the danger of cracking of the means for containing during impact from physical stress, such as wind and wave action.

32. The aquaculture tank of claim 28, wherein the invention further includes:
means for automatically feeding the fish or other species contained within said aquaculture tank.

33. The aquaculture tank of claim 28, wherein the invention further includes:
means for distributing oxygen through the water within the aquaculture tank to maintain healthy levels of available oxygen in high-density living conditions of the farm-raised fish or other aquatic species contained within the aquaculture tank; and
wherein said means for distributing oxygen may also include a means for producing and a means for storing oxygen for on-site use.

34. The aquaculture tank of claim 28, wherein the invention further includes:
means for pumping water from different depths of the surrounding body of water into the aquaculture tank to regulate temperature within the aquaculture tank year-round and to provide a source of oxygenated water to the aquaculture tank.

35. The aquaculture tank of claim 28, wherein the invention further includes:
means for harnessing and storing wind, wave, or solar energy to power any electrical or mechanical components included as a part of the invention, including, but not limited to, lights, air blowers or pumps, water pumps, and feeding systems.

36. The aquaculture tank of claim 28, wherein the invention further includes a solid waste recovery system comprising:
means for recovering wastes from the means for containing;
means for holding and storing wastes temporarily;
means for separating solid wastes from water and liquid wastes;
means for releasing water and liquid wastes into the surrounding body of water; and
means for pumping said solid wastes to a service barge or other disposal unit.

37. The aquaculture tank of claim 28, wherein the invention further includes means for covering partially or entirely an open end of said means for containing to protect the fish or other species from predators, such as birds.

38. The aquaculture tank of claim 28, wherein the invention includes means for anchoring said means for containing in a stationary position within a body of water.
